(19) United States
(12) Patent Application Publication
(10) Pub. No.: US 2010/0218224 A1
(43) Pub. Date: Aug. 26, 2010

(54) System and Method for Low Cost Mobile TV

(75) Inventors: Yoel Gat, Ramat Raziel (IL); Ilan Kaplan, Rockville, MD (US); Danny Spirtus, Holon (IL); Mario Gachev, Sofia (BG)

Correspondence Address: D. Kligler I.P. Services LTD, P.O. Box 25, Zippori, 17910, IL

(73) Assignee: RaySat, Inc., Vienna, VA (US)

(21) Appl. No.: 12/718,975

(22) Filed: Mar. 7, 2010

Related U.S. Application Data
(63) Continuation-in-part of application No. 12/325,918, filed on Dec. 1, 2008.
Application No. 12/325,918 is a division of application No. 11/324,755, filed on Jan. 4, 2006, now abandoned.
Application No. 12/325,918 is a continuation-in-part of application No. 11/074,754, filed on Mar. 9, 2005, now abandoned.
Application No. 11/074,754 is a continuation-in-part of application No. 11/071,440, filed on Mar. 4, 2005, now abandoned.
(60) Provisional application No. 60/650,122, filed on Feb. 7, 2005.
(60) Provisional application No. 60/653,520, filed on Feb. 17, 2005.

(51) Int. Cl. H04N 7/20

(52) U.S. Cl. 725/72

(57) ABSTRACT

A low profile low cost mobile in-motion antenna system for satellite TV reception using DVB with different either BPSK or CDMA like modulation schemes is described. In some embodiments, a low resolution version of a video transmission may be used as a backup for a higher resolution version of the video transmission.

### CROSS REFERENCE TO RELATED APPLICATIONS

The present application is a divisional of U.S. application Ser. No. 11/324,755, filed Jan. 4, 2006, which claims benefit under 35 USC §119(c)(1) of U.S. Provisional Application No. 60/650,122 filed Feb. 7, 2005, and of U.S. Provisional Application No. 60/653,520, filed Feb. 17, 2005; and is a continuation-in-part of U.S. application Ser. No. 11/074,754, filed Mar. 9, 2005, U.S. application Ser. No. 10/925,937, tiled Aug. 26, 2004, U.S. application Ser. No. 11/071,440, filed Mar. 4, 2005, U.S. application Ser. No. 11/320,805, filed Dec. 30, 2005, and PCT/US05/28507, filed Aug. 10, 2005. Each of the foregoing applications is hereby specifically incorporated by reference in their entirety herein. With respect to any definitions or defined terms used in the claims herein, to the extent that the terms are defined more narrowly in the applications incorporated by reference with respect to how the terms are defined in this application, the definitions in this application shall control.

### BACKGROUND OF THE INVENTION

1. Field of the Invention

The present invention concerns a microwave antenna terminal applicable to mobile communication systems using geostationary satellites, and capable of supporting either one-way satellite TV reception or concurrent two-way data transfer and satellite TV reception.

2. Description of the Related Art

One disadvantage of existing two-way systems, whether fixed or transportable, is their considerable height and unattractive appearance, limiting applications and customer appeal for moving platforms. A further disadvantage is the inability of existing systems and technologies for land based vehicles to provide mobile systems with broad band two-way data communications, including Internet and telephone access, that would enhance communication capabilities for commercial, recreational and any other mobile-based activities, using a variety of vehicular transportation in both densely populated and remote locations. Yet another disadvantage is the inability of existing systems and technologies to provide mobile systems with a combination of concurrent two-way data communications and television reception capabilities for commercial, recreational and other activities. In the present satellite TV reception configurations, cost is a concern since there are no low cost, low profile, mobile receivers. The systems contemplated herein may be operated while being moved by a transport mechanism (e.g., cars, planes, busses, or other vehicle) from one place to another, and the operation include cases when the vehicle is parked, i.e. stationary.

### SUMMARY OF THE INVENTION

A low profile mobile antenna and transmit/receive terminal system for TV reception and optionally two-way data type communication using data, phone, VOIP, and other service. Where two way transmission is used, it may utilize frequencies in a first frequency band, supporting at the same time concurrent TV signal reception of signals broadcast in a second frequency band. The communication may be with the same satellite or with two or more satellites located at the same or close geo-stationary orbital position.

In aspects of the invention, the system may enable a low cost antenna by substantially reducing the size of conventional mobile antennas using a different modulation scheme from that contemplated by the DVB specification. For example, it has been found that BPSK with FEC ¼ and/or CDMA can substantially reduce the inception antenna size/footprint for mobile applications.

In embodiments using the current DVB standard, antennas are typically at least a meter in diameter or more. Such antennas arc difficult to mount on smaller luxury cars. Further, they increase the drag on the cars and can reduce gas mileage. By contrast, the present antenna is much smaller enabling it to be easily mounted in a variety of locations, substantially reducing the cost of the antenna, improving the aesthetics, and reducing the drag and wind profile.

In aspects of the invention, there is provided a method and apparatus for a low profile mobile terminal receiving a direct television signal including an antenna receiving a DVB formatted television signal using a modulation scheme other than the one in the DVB standard for decreasing the size and cost of the mobile antenna.

In aspects of the invention, there is provided a method and apparatus for a low profile mobile terminal receiving a direct television signal including an antenna receiving a DVB formatted television signal using BPSK modulation.

The apparatus and method may further include an antenna integrated into a vehicle and is electro-mechanically or fully electronically adjustable to track a satellite in both azimuth and elevation. In exemplary aspects of the invention, the antenna system and method may include a one antenna array 12″ to 28″ in length and operative for reception of television signals from at least one satellite.

The system and method of aspects of the invention may also include a fiat antenna army wherein the length of the antenna array is about 14 inches to 20 inches in length.

The system and method of further aspects of the invention may also include a flat antenna array having a length of about 16 inches, further, aspects of the invention may include BPSK modulation with FEC=¼.

Systems and methods of the present invention may also include a low profile mobile terminal for receiving a direct television signal comprising an antenna receiving a DVB formatted television signal using CDMA modulation.

In further aspects of the present invention, the low profile reduced size antenna may enable the applications of broadband data communications and satellite TV reception at a wide variety of moving vehicles such as recreational vehicles (RVs), sport utility vehicles (SUVs), buses, trucks, trains, cars, automobiles, boats, and even aircraft. For example, one application would enable passengers in a vehicle to make a wireless “always on” broadband connection to the Internet from a personal computer inside the vehicle at the same time that other passengers are watching satellite TV broadcasts from, for example, the EchoStar Dish or Hughes' DirecTV network. This could be done in a consumer vehicle and also in commercial vehicles such as buses, planes and trains. In that case, passengers could open their laptop computers and perform customary Internet functions such as e-mail and Web browsing. Other passengers could be watching satellite TV.

Further, the application of the present antenna could be adopted by any multiple system operator who already has content (such as a cable provider) to supply signals to rural users who do not have cable network access using many commercially available Ka or Ku band satellite space. This space segment is readily available and will allow competition by MSO with conventional satellite providers such as Dish and DirecTV.

In another example application, the two-way satellite connection and the Global Positioning System (OPS) information included with the system and method, can provide the location of the vehicle and interface with the vehicle's telematics system to provide up-to-date downloads of information for navigation, location of local hotels, restaurants, and local point of interest, VOIP phone access. The active two-way communication link can also be used to obtain real time emergency assistance where the vehicle's location would be communicated to the emergency assistance organization.

For commercial vehicles such as trains, buses and aircraft, the Internet connectivity enabled by the invention allows provision of wireless “hot spots” covering the inside of the moving vehicle. The satellite TV portion of the system could also be used to distribute programming to individual seats, if desired.

For commercial trucks, the invention combines vehicle location information and “always on” connectivity that may be used for dispatch, tracking of vehicles, productivity data on drivers, and routing by a central authority.

### BRIEF DESCRIPTION OF THE DRAWINGS

Embodiments of the invention arc described below in detail with reference to the following drawings in which like reference numerals refer to like elements wherein:

FIG. 1 is an illustration of a communications system with which the present invention is employed.

FIG. 2A is a cross section of a first embodiment of a transmit/receive low profile terminal in accordance with aspects of the present invention and FIG. 2B is a second embodiment of such terminal having an extremely low profile such that the antenna terminal could be integrated within the roof of the vehicle with little or no protrusion above the vehicle.

FIG. 3A illustrates block diagram of the received only antenna terminal in accordance with the embodiment of the invention.

FIG. 3 illustrates block diagram of the transmit/receive mobile antenna terminal in accordance with embodiments of the invention.

FIG. 4 is a schematic illustration of the flow of circularly polarized signals that may be received by the mobile antenna terminal in accordance with aspects of the present invention.

FIG. 5 illustrates signal flow through the various components on the Rs and Tx sides for both bands for a transmit receive embodiment of the invention.

FIG. 6 illustrates a flow chart of an exemplary process performed in the implementation of the present invention.

FIG. 7 is a pictorial view of an antenna in accordance with aspects of this invention disposed on the roof of a vehicle.

FIG. 8 shows a comparison between two aspects of the present invention: full spread spectrum and RPSK with R ¼.

FIG. 9 shows an exemplary embodiment of the full spread spectrum system of FIG. 8 with direct sequence spread spectrum multiplying the DVB signal by a PN (pseudo noise) sequence of +1, −1.

FIG. 10 is a block diagram of the transmit section of the spread spectrum embodiment of FIG. 9.

FIG. 11 is a block diagram of the receive section of the spread spectrum embodiment of FIG. 9.

FIG. 12 is another embodiment of the receive section of FIG. 11.

FIGS. 13-15 show a mockup of exemplary embodiments of the present invention mounted on a vehicle.

### TECHNICAL DESCRIPTION OK THE INVENTION

The following describes in detail exemplary embodiments of the invention, with reference to the accompanying drawings.

The claims alone represent the metes and bounds of the invention. The discussed implementations, embodiments and advantages are merely exemplary and are not to be construed as limiting the present invention. The description of the present invention is intended to be illustrative, and is not intended to limit the scope of the claims. Many alternatives, modifications and variations will be apparent to those skilled in the art.

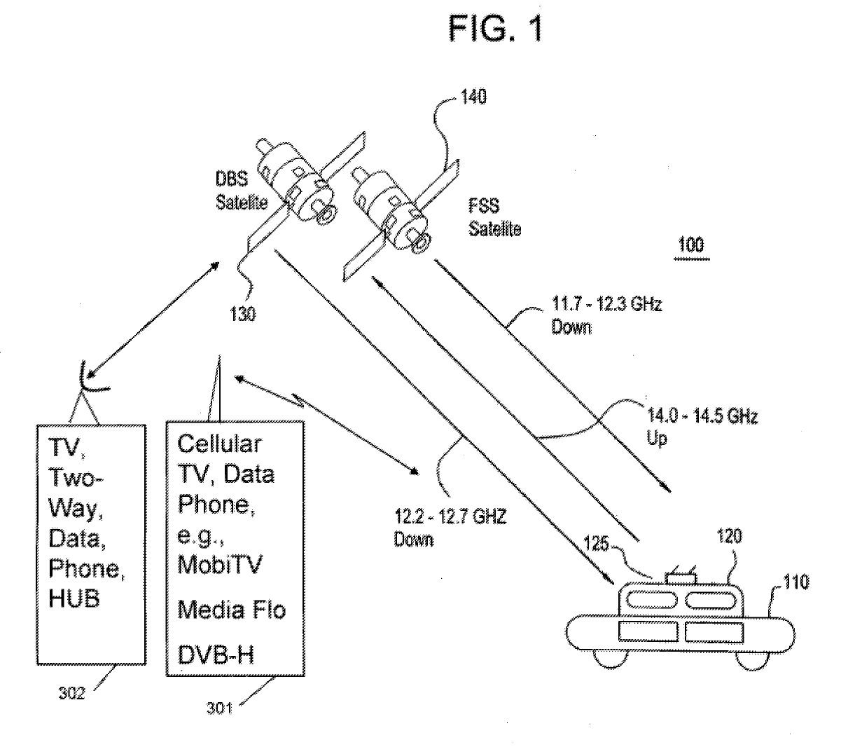

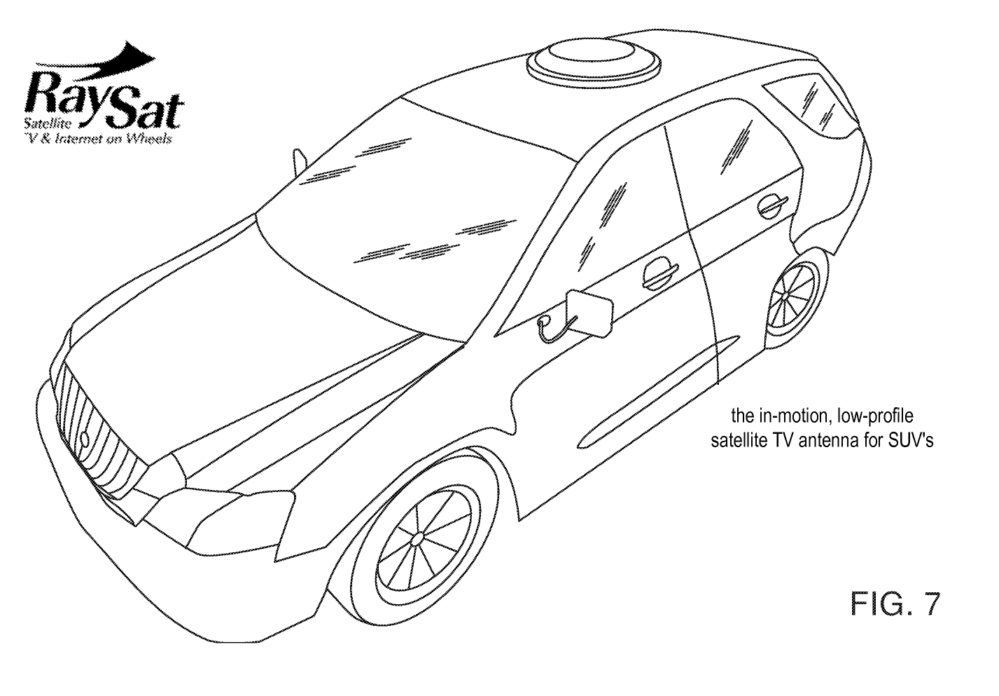

Aspects of the present invention provide a system and method for providing low cost, low profile, mobile satellite antennas for use with satellite television transmission. See, for example, the antenna depicted in FIG. 7. The antenna may also be utilized with a terminal system that is suitable for use with a variety of vehicles, for in-motion satellite communications in support of concurrent two-way data transfer and satellite broadcast TV reception. With reference to the illustration in FIG. 1 of an exemplary system 100 in which the invention may be employed, a mobile vehicle 110 has mounted thereon a terminal system 120 that is adapted to communicate with a satellite having a television signal. The satellite (or an adjacent satellite) may simultaneously provide two-way connectivity with the vehicle antenna. This satellite(s) are preferably co-located in geostationary orbit. One satellite 130 may be variously configured such as a direct broadcast satellite chat provides television signals on a downlink at a frequency within a range assigned by an appropriate body. Rather than the conventional direct broadcast satellites, the system and method may also utilize a Ka or Ku band satellite. In one preferred embodiment, AMC 15 located at 105 west longitude is utilized. Other satellites may also be used as allocated by the Federal Communication Commission (FCC) in the U.S. or similar agency in Europe or other regions.

A second satellite 140 may be variously configured to support two way data and/or further television signals. In either event, the satellite is preferably co-located with the first satellite. The satellite may provide television data and/or two-way data communication at uplink and down link frequencies that also arc assigned by the FCC.

In alternative embodiments, a single satellite could provide both the television broadcast and two-way date communications services, and two or more satellites could be substantially co-located to provide such services. Effective communication from a single mobile in-motion terminal with multiple satellites would require the satellites to be within the beam width of the terminal antenna. In short, the features of the invention are not limited by the number of satellites engaged in the communication service.

In an exemplary embodiment relevant, for example, in the U.S., two-way data communications and/or TV channel reception is provided by using one or more satellites in the U.S. Fixed Satellite Service (FSS) frequency band of 11.7-12.2 GHz for reception (downlink or forward link) and 14.0-14.5 GHz for transmit (uplink or return link). Using this example, 4 to 6 transponders could provide 20-30 television channels and 200-300 radio channels.

While conventional DBS and BSS frequencies may be used with this invention, some modification to conventional receivers may be required via software download or otherwise to utilize the smaller antenna sizes. Thus, TV programs reception in 12.2-12.7 GHz Direct Broadcast Satellite (DBS) or Broadcast Satellite Service (BSS) band from the same or close orbital location can also be received (assuming the modulation scheme is appropriate), thus allowing the low-profile, mobile, low cost antenna to receive many channels. However, due to the installed base, the DBS and/or BSS frequencies may not be utilized at first, at least until there is an installed base in the mobile environment to warrant converting over conventional receivers.

In any event, both the DBS and/or BSS tuners can implement a CDMA and/or BPSK demodulator which is not enabled until some later point in time. Then as some point in time, all receivers could then be switched over to a different type of modulation scheme. Alternatively, a different service could be offered for mobile applications and/or home users who desire a smaller, less intrusive, antenna for their home.

The terminal system 120 includes may be variously configured to include an antenna 125 that is mounted on or into the roof of the vehicle and, preferably, has a low profile form that is attractive for application to mobile platforms, such as cars (particularly luxury cars), sport utility vehicles (SUVs), vans, recreation vehicles (RVs), trains, buses, boats or aircraft. The lower profile facilitates terminal installation directly on or into the roof of the mobile platform, keeping the overall aerodynamic properties of the vehicle almost unchanged. The terminal system 120 also has a communications subsystem that is operative 10 provide the concurrent two-way data and television reception capability by appropriately processing the uplink and downlink signals at different frequency bands.

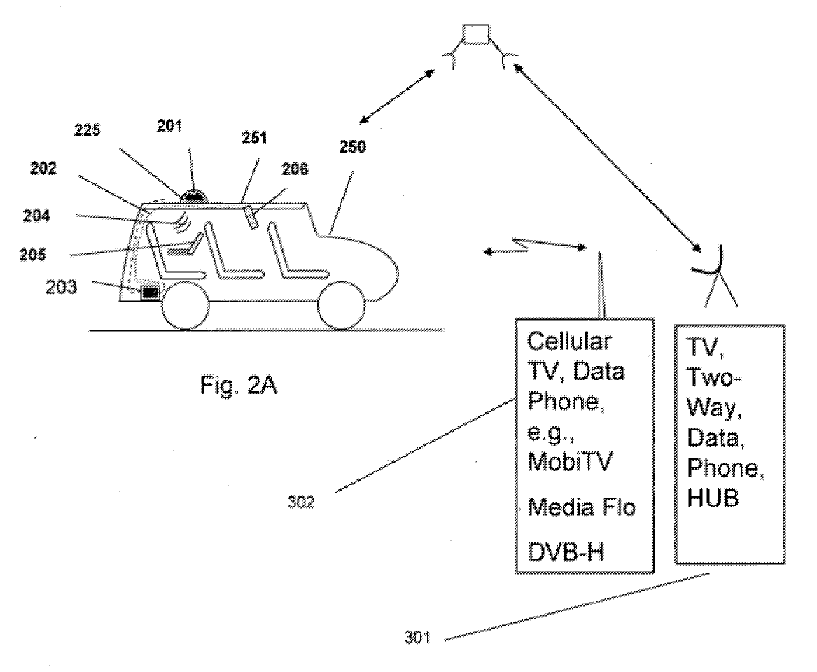

FIG. 2A illustrates a first embodiment of such a terminal 225, which has an antenna and related electronics (not shown) contained within an outer shell 201 having a low profile, such that the shell 201 can be externally mounted to the roof 251 of the vehicle 250 with little or no protrusion above the vehicle. This terminal could employ, for example, the electro-mechanically steered antenna of the type disclosed in the patent application U.S. Ser. No. 10/752,088 entitled Mobile Antenna System for Satellite Communications”, herein incorporated by reference. Alternatively, the shell can contain a flat (or very low thickness) phased array system comprising one or more relatively thin arrays and using either electro-mechanical steering or all electronic steering to track the satellites, such as the electronically steered antenna of the type disclosed in the patent application entitled “Flat Mobile Antenna,” which was filed as a PCT application (PCT/BG/04/00011) and designates the U.S. for national stage filing, also herein incorporated by reference.

The components within the shell 201 may be coupled by cables 202 and/or other suitable mechanism (e.g., wireless) to an interior unit 203, which can contain the components necessary for data and video processing that can be off-loaded in order to reduce the profile of the shell 201. The interior unit can be coupled by the cables 202 to a video display 206 or jack for a computer or other data interface device. As illustrated in FIG. 2A, the system could include a wireless two-way connection 204 for coupling to a laptop 205 or similar device.

For example, various devices such as MP3 players, iPods including video iPods, and various other portable video and audio players may be utilized. In an exemplary embodiment, a vehicle may be configured with a terminal for the aforementioned devices allowing integration into the system. For example, a video iPod may be utilized to display real time programming and applications as well as programming and applications stored locally. The illustrative video iPod may thus be empowered to perform store and forward downloads of applications and programs via the system. These illustrative devices may be used coincident with operation of the vehicle or even when the vehicle is parked or not in use. These features may permit the downloading of movies and television programming. Additionally, computer games and other applications may be downloaded. As such, various game consoles may also be integrated and game control may be formed. These capabilities, as illustrated further herein, facilitate user access to a wide array of applications, programming, entertainment, and media.

Other embodiments of the invention may be variously configured to comprise an antenna panel (e.g., phased array) with fully electronic beam steering, along with polarization adjustment, of the type already mentioned. An extremely low profile of antenna package can be achieved, allowing antenna terminal integration within the vehicle roof. With reference to FIG. 2B, there is illustrated a cross section of a vehicle 250 having an antenna 260 that is integrated into the roof 251 of the vehicle 250, and is electro-mechanically and/or electronically steerable in both azimuth and elevation. The antenna could either be mounted so that its top is substantially coplanar with the vehicle roofline, requiring the antenna's minimal depth to be accommodated within the space between the roof and the vehicle cabin, or mounted so that its depth appears as a slight bulge in the roofline.

The mounting to a standard vehicle in either case could be achieved by cutting a hole in the roof and affixing the antenna into the hole, and/or mounting the antenna to the roof rack, and/or mounting the antenna to the top of the car, hood, or trunk using any suitable mechanism such as screws, bolts and/or a magnet. In still alternate embodiments, with appropriate interior and exterior finishes and gaskets, much in the same manner that sun roof's are added to standard vehicles, the satellite antenna can be made to appear on the roof of a vehicle with the touch of a button.

In exemplary embodiments of the invention, the top surface may have an appropriate coating or covering that can be weatherproof and durable, yet offer minimal interference with the transmission or reception of signals to and from a satellite. The antenna may be coupled to internal electronics, such as display and data interface or processing equipment through wired or wireless connections, in the same manner as in FIG. 2A.

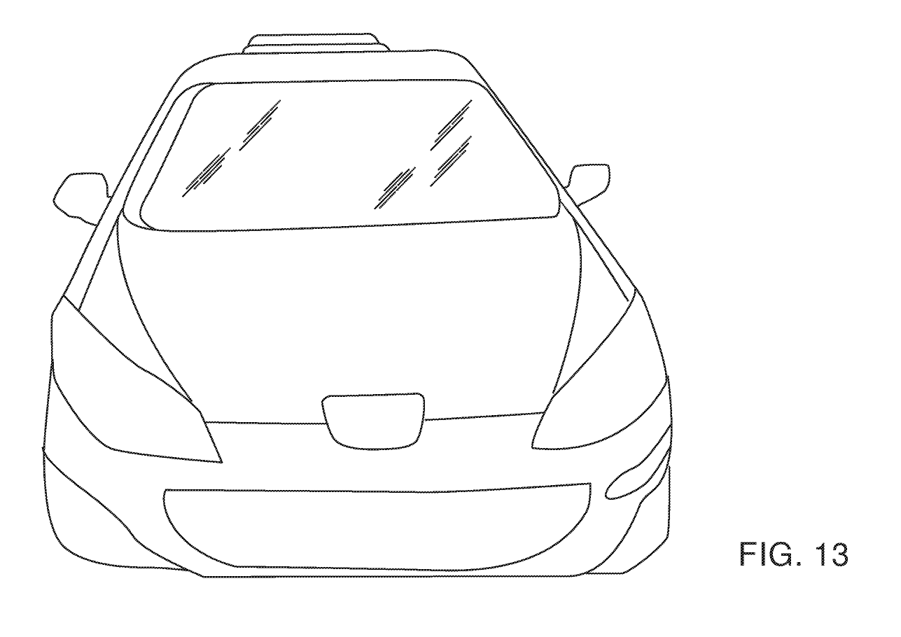

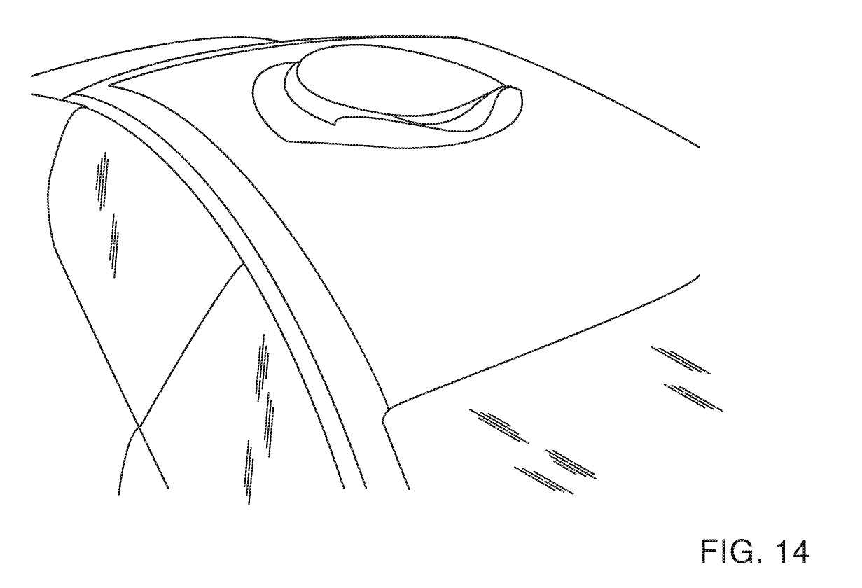

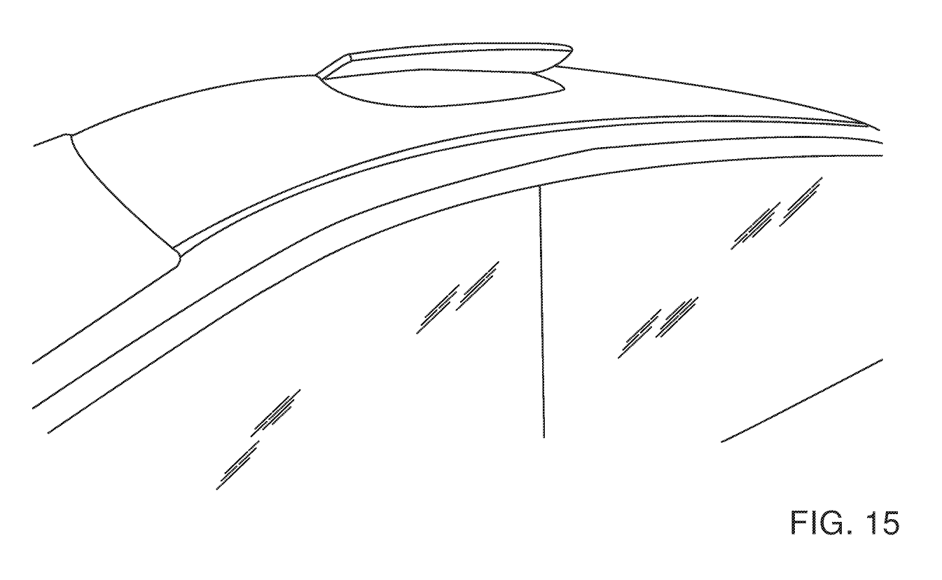

FIGS. 13-15 show a mockup of exemplary embodiments of the present invention mounted on a vehicle.

The proposed low profile antenna terminal which meets the above-mentioned objective, may include a low profile transmit and/or receive antennas, beam control system, sensors, down and up converters, modems, radio frequency (Rf) power amplifiers, and/or interface for interfacing with data and TV receivers.

It is clear that similar terminals for different frequency bands, e.g. portions of the bands available in Europe and elsewhere in the world (e.g., 10.7-12.75 GHz for reception and 13.75-14.5 GHz for transmission), are included within aspects of this invention. The frequencies in the examples were chosen for the FCC dictated frequencies in the U.S., similar frequencies such as those prescribed in Europe or Asia could also be utilized.

A system that functions as a low-profile in-motion, low cost data and television reception system is not presently available. Additionally, where only the receive function is supplied, the system is even more cost effective.

The low profile transmit and receive antennas comprise one or several flat antenna arrays, in the form of panels according to a non-limiting example. In one preferred embodiment, only a single receive panel is utilized. This embodiment provides a very low cost solution. In other embodiments, other receive panels may be utilized.

In any event, the panels may be variously configured, for example, with each panel containing a plurality of dual port radiating elements (patches, apertures etc.), passive summation circuits and active components. In these embodiments, each antenna array may have two independent outputs each one dedicated to one of the two orthogonal linear polarizations. In case of a multi-array or multi-panel antenna embodiment, signals coming or going to the different antenna arrays are phased and summed or divided by final combining block, with phase and amplitude controlling components.

The signals from the two antenna outputs with two orthogonal linear polarizations may then be processed in polarization control devices in order to adjust the polarization tilt in the case of linear polarization. Such adjustment may be implemented by using the information for antenna terminal position with respect to the selected satellite, received by a GPS device and for the vehicle inclination angle, received, for example, by an inclination sensor or gyroscope.

Continuing with this example, receive panel outputs may lie processed for circular polarization in the case of U.S. DBS reception. Another possibility for providing a polarization adjustment is to use the −3 dB symmetrical points (45 degree tilt) or by checking the antenna cross-polarization at the hub station.

In one embodiment, the signals coming from the receive antenna outputs may be divided and applied to two independent down converters comprising the polarization forming circuits and dedicated to reception separately in the FSS and DBS/BSS bands. In these embodiments, it may be desirable to form two orthogonal linear polarizations with adjustable polarization offset for processing the signals in the FSS band and at the same time two circular polarizations for processing signals in the DBS/BSS band.

In still other embodiments, the transmit and receive antennas may be arranged on the same rotating platform in order to ensure exact pointing to the selected satellite using tracking in receive mode.

In may be useful in some embodiments to stack the signals at a first intermediate frequency, connected with the two (LH and RH) circular polarizations, coming out of the two DBS down converters, and to transfer them to the static platform of the terminal using one and the same rotary joint device.

In yet another embodiment, the signal transfer between static and rotary platform may be made using a wireless connection (using for example Wi-Fi or Bluetooth technology) thereby eliminating the need for a rotary joint for the continuously rotatable azimuth platform. Where Bluetooth technology is utilized, a satellite may provide cellular like phone service by connecting directly to the blue tooth receiver unit.

In still further another embodiments, the connection between outdoor unit set top box and the indoor equipment in the vehicle also may be accomplished using wireless technology (for example Wi-Fi or Bluetooth technology).

In some embodiments, the beam pointing may be accomplished by mechanical rotation in azimuth plane of the platform, comprising transmit and/or receive antenna panels, and by mechanical, electronic or mixed steering in the elevation plane. In certain cases, beam steering in azimuth and elevation could also be accomplished by entirely electronic means.

The motors or electronic steering components may be controlled by a CPU using the information, supplied by the direction sensor (such as a “gyro”) and received signal strength indicator (RSSI) blocks.

In applications of the invention, a low profile antenna terminal, of the type schematically illustrated in FIGS. 2A and 2B, for television reception and/or in-motion two-way communications from satellite(s) at about the same geo-stationary orbit or, orbits for the FSS and BSS functions.

FIGS. 1, 2A, and 2B also show the use of a hub 301 having satellite TV, two-way data, VOIP, and other data. Additionally, these figures show a Cellular network 302 including cellular TV, Data, and phone which may overlay a terrestrial system such as a cellular telephone network. Non-limiting examples of such a system include MobiTV, Media Flo, DVB-H and other similar such systems. Satellite TV reception in cars is often limited in large cities where tall buildings can often obscure the line of site to the antenna. Fortunately, these cities have robust cellular networks. The cellular networks are undergoing a transformation in order to support an overlay of comparatively low resolution television data. The present system enables the user to switch over the cellular overlay network when in big cities at a reduced resolution. Thus, the picture is not lost entirely as in previous satellite systems, but only degraded.

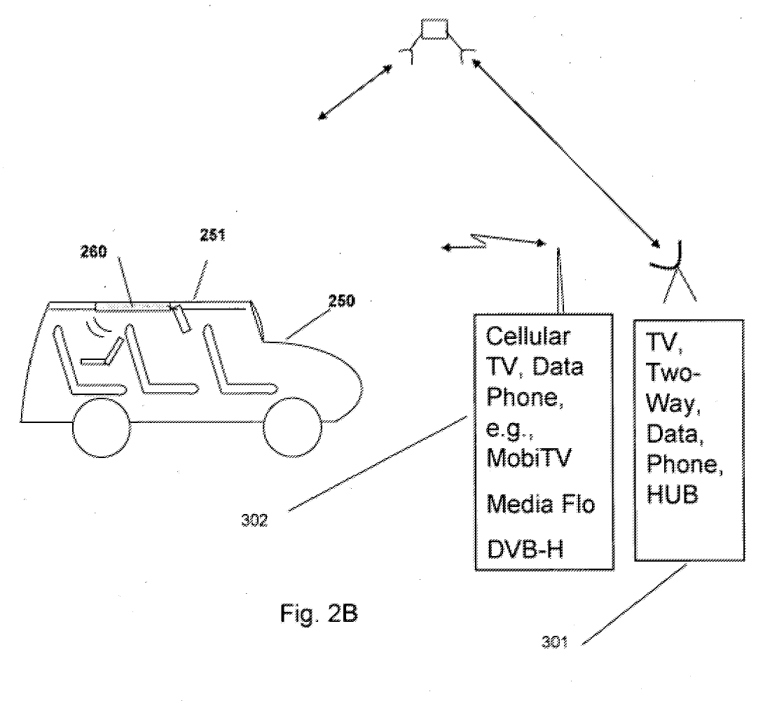

Still referring to FIG. 1-2, the system 100 may include a very simple, low profile receive only terminal, illustrated in FIG. 3A. The terminal may comprise an outdoor unit 600 and indoor unit 601. The indoor unit 601 may be configured to include Wi Fi 604 connected with the equipment installed in the vehicle. The equipment may include satellite receiver 602 and video display 603 or in another possible embodiment PC, laptop or other communication equipment. The outdoor unit 600 may comprise a flat antenna panel 605 comprising plurality of dual port antenna elements, combining networks and amplifiers in order to compensate the losses in the combining networks (e.g., the antenna panel architecture and technology used arc described in detail in the patent application “Flat Mobile Antenna” PCT/BG/04/00011). The antenna panel 605 may be configured to include two outputs combining respectively the received signals from all horizontal and vertical antenna elements ports. The two independent signals may then be transferred to the polarization forming device 606. In the polarization forming device 606 the amplitude and phase of the each one of the two independent signals may be controlled and then properly summed in order to form the preferred signal polarization. The polarization could be Left hand Circular (LHCP), Right Hand Circular (RHCP) or linear vertical or horizontal or tilted linear polarization with the polarization tilt selectable to +/−90 degrees. The signal with the required proper polarization may then be split and transferred to a dual down converter 607 in order to be down converted to the First intermediate frequency in L band. The outputs of the down converter may then be connected to the Received Signal Strength Indicator (RSSI) device 608, which may provide information for the current strength of the signal received by the antenna to CPU 611 as needed in the process of satellite tracking.

The CPU device 611 may be variously configured and in one embodiment includes a digital processing unit, motor control circuits and power supply circuits. The CPU 611 may be configured to control the elevation 612 and azimuth 613 motors in order antenna beam to stay pointed to the preferred for communication satellite while in motion. The optimal position of the antenna beam may be calculated by the CPU 611 using the information for platform rotation provided by the gyro sensor block 614 mounted on the antenna panel's back and the information for current strength of the received signal provided by the RSSI device 608. The outdoor unit power supply and intermediate frequency signal may be transferred through the common low cost rotary joint 610 to the static platform (antenna terminal base) 615 and then through the single coaxial cable to the indoor unit 601 inside vehicle. The indoor unit comprises power supply unit, satellite recognition device, power injector and interface to the communication equipment installed in the vehicle. In one preferred application the interface may be wireless.

Still referring to FIGS. 1-5, a system 100 may include a two-way (receive/transmit) terminal 120 including a low profile antenna 125, 225 rotating platform 11, static platform 13 and/or indoor unit 14. The rotating platform may include transmit (Tx) 30 and/or receive (Rx) 31 sections. The preferred shape of the antenna 125 comprises thin arrays, in a non-limiting embodiment, flat panels, in order to decrease the overall height of the overall system. A terminal based on reflectors or lenses is feasible but generally will occupy a substantially larger volume on the vehicle and may be less attractive in some mobile applications, but would be suitable for stationary applications.

The antenna array may be a panel constructed using phased array antenna technology and comprising a plurality of dual port radiating elements (e.g., the antenna panel architecture and technology used are described in detail in the patent application “Flat Mobile Antenna” PCT/BG/04/00011), designed to work in transmit mode in the 13.75-14.5 GHz frequency band, which is incorporated herein by reference.

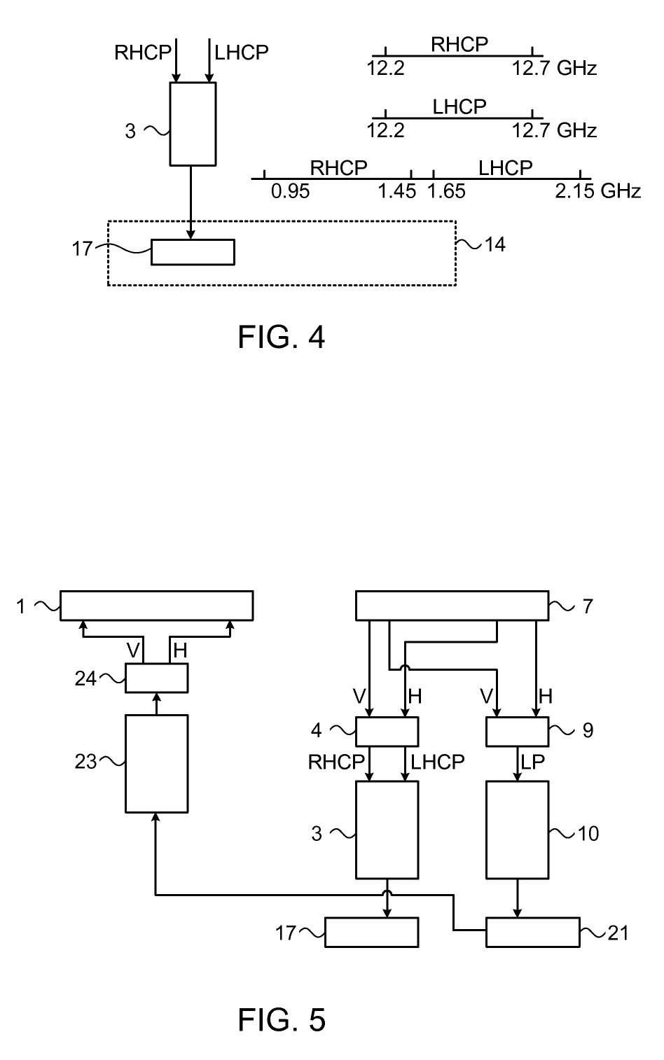

As illustrated in FIGS. 3 and 5, the transmit section may be configured to include a flat active antenna array 1, polarization control device 24 up converter unit 23. High power amplifiers (HPA) 2 modules may be integrated directly to each one of the array inputs in order to minimize signal losses between the up-converter unit 23 and radiating elements of the array 1, in the two-way embodiments. The transmit signal formed in, for example, the IF/baseband transceiver block 21, which may also be disposed on rotating platform 11, and can be up converted in a standard up-converter unit 23 and then transferred through polarization control device 24 to the transmit panel inputs. The polarization control unit 24, when utilized, may include electronic controlled phase controlling devices and attenuators, which may be configured to control the amplitude and phase of the signals applied to each one of the antenna array inputs (or integrated with the antenna array/sub array elements).

The vertical (V) and horizontal (H) polarized outputs of the polarization control unit 24 may be variously configured such as being connected through two independent feed networks to each one of the two port sets of the dual port radiation elements. In this embodiment, control of the polarization tilt of the transmitted linearly polarized signals can accomplished. Specifically, the polarization offset can be established, depending on the vehicle location with respect to the selected satellite, using the information from a GPS module 18 and/of an inclination sensor 29. Polarization tilt information may also be obtained by monitoring the cross polarized channels of the satellite.

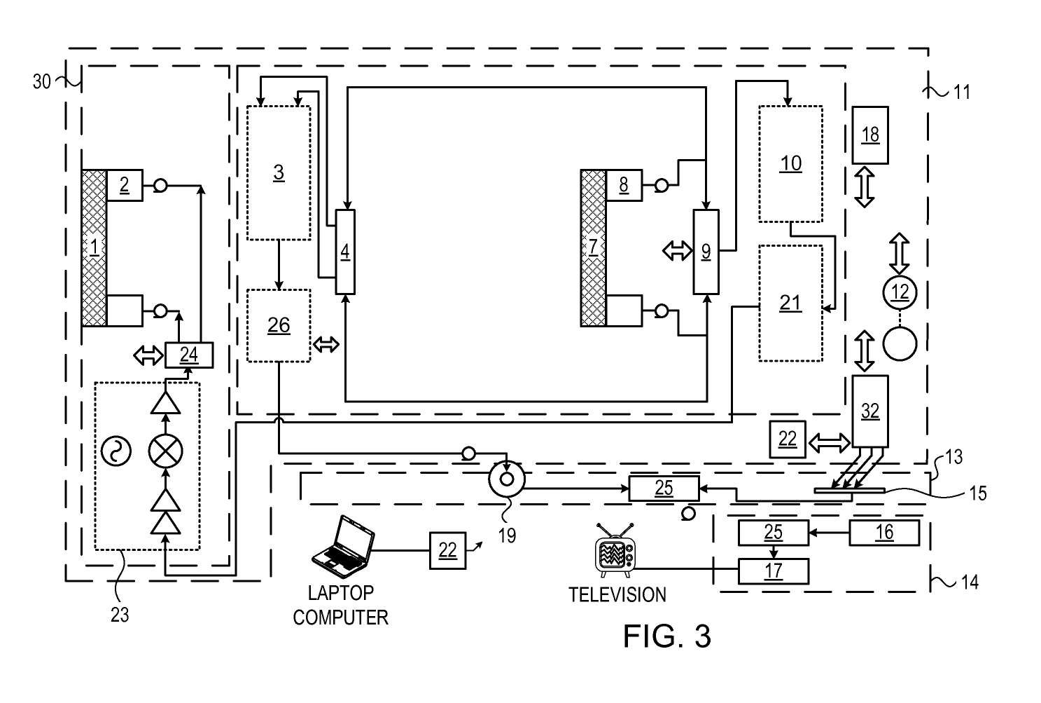

With reference to the illustration in FIGS. 3 and 5, receive section 31 may include a single ½ panel receive antenna array, implemented in the exemplary illustrated embodiment by array 7 situated on the same rotating platform 11 with the transmit array 1 (when a transmit array is utilized). The receive array may be variously configured, but where BPSK modulation is utilized, it may be ½ the length of the array described in U.S. patent application Ser. No. 10/925,937, herein incorporated by reference. The arrays, particularly when implemented as panels, may be aligned to have the same directions of the main beams. For example, array 7 may be configured just for the FSS frequency band (11.7-12.2 GHz) and/or may be configured for an extended frequency band of operation in order to cover simultaneously both FSS (11.7-12.2 GHz) and DBS (12.2-12.7 GHz) bands, as an example for the U.S. operation. Low noise amplifiers (LNAs) 8 may be connected to the panel's output(s)/polarization(s). The elevation angles and the distances between the receive panels (where multiple receive panels are used) in exemplary embodiments (fully mechanical embodiments) may be controlled by the elevation mechanics 12 in order to achieve best performance in the entire elevation scan range. The principles of operation and construction of such type of multi-array or multi-panel antenna receive system are disclosed in the patent application U.S. Ser. No. 10/752,088 Mobile Antenna System for Satellite Communications, the disclosure of which is incorporated herein by reference.

Where multiple receive sections are utilized, it may be desirable to have one or more combining and phasing blocks (not shown), where, for example, each one is dedicated to one of the two independent linear polarizations (designated as V-vertical and H-horizontal). Where utilized, these combiners may be operative to properly phase and combine the signals coming from the antenna panels outputs and to supply H-polarized and V-polarized signals to the polarization control device 9 and polarization forming device 4. However, where a low cost television receive panel is desired, only a single antenna panel is utilized and the combing and phasing blocks need not be utilized. Polarization control device 9 is operative to control and match the polarization offset of the linearly polarized FSS signals with respect to the satellite position, using the information supplied by GPS module 18 and/or possibly the inclination sensor 29. Polarization forming device 4 is operative to form a left hand circular polarization (LHCP) and a right hand circular polarization (RHCP) which may be desirable for processing DBS signals. The RHCP and LHCP signals may then be provided to down converter 3, and may also be forwarded to the receiver 17 in the indoor unit 14, as illustrated in FIG. 4. In another embodiment, the DBS receiver could be located with the outdoor terminal equipment and a digital wired or wireless connection be enabled to the indoor video display.

The down convener 10 receives the FSS signals, while the down convener 3 receives the DBS signals. In one non-limiting but exemplary implementation, a rotary joint 19 is used to supply down converted signals coming from the DBS down converter 3 to the indoor unit. The signals, which relate to the left hand (LH) and right hand (RH) polarizations, are stacked in frequency using a stacker circuit, integrated into the DBS down converter 3, in order to use one and the same rotary joint unit 19. The IF signals coming from the FSS down converter 10 are supplied to the IF/baseband transceiver block 21, which is connected to the indoor equipment (inside the vehicle). The connection to the indoor unit may he wired or wireless. Where the connection is wireless, it may employ wireless modules 22.

A received signal strength Indicator (RSSI) and recognition module 26 and the IF/baseband transceiver block 21 may be connected to the FSS down converter 10 and the up converter 23, and all may be arranged on the same rotation platform.

As illustrated in FIG. 3, a low cost gyro sensor block 6 may be placed on the back of one of the receive panel(s) and will be operative to provide information about the platform movement to the digital control unit 32. The digital control unit 32 is operative to control the motor(s) 12 (where utilized) for beam steering in azimuth and elevation. Polarization controlling devices 24 and 9, together with optional phase combining and phase control blocks (not shown), may further interface with the gyro sensor block 6, inclination sensor 29 and indoor unit 14.

The static platform may be variously configured to include DC slip rings 15 or other suitable mechanism in order to transfer DC and/or digital control signals to the rotating platform, static part of the RF rotary joint 19, part of the azimuth movement mechanics, DC power injector 25 and the terminal supporting structure, which typically is in the form of a case.

The indoor unit 14 includes digital and DC power supply interface 16, satellite receiver 17 and power injector 25 in order to supply DC to the outdoor unit.

In the VSAT system for data communications, a digital interface may be provided for PC, telephone line, and the like, either on the rotating platform or in the vehicle.

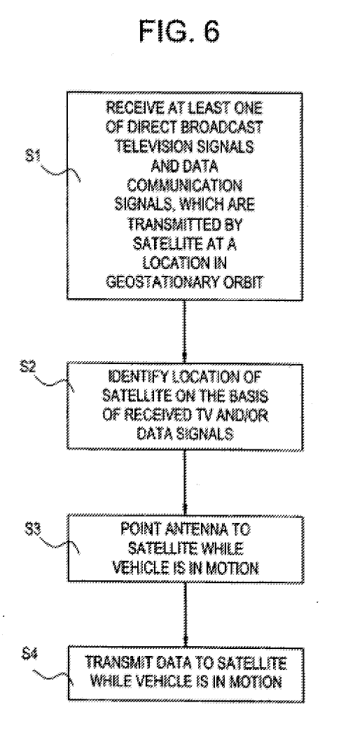

The communications terminal as disclosed herein can operate in a manner that can provide in-motion mobile communication for direct broadcast satellite television reception and/or two-way data communication. According to the method, as illustrated in FIG. 6, at an antenna coupled to a mobile terminal mounted on a vehicle in motion (e.g., car, truck, or the like suitable for carrying a low profile antenna), at least one of direct broadcast television signals and data communication signals, which are transmitted by satellite at a location in geostationary orbit, are received (step S1). The reception (when using a reduced size, low profile, mobile antenna), preferably uses BPSK (e.g., ¼ BPSK) or full spread spectrum. At the mobile terminal the orbital location of the one (or more satellites in substantially the same location, within the beam width of the mobile terminal antenna) is identified (Step S2), preferably using an RSSI module or similar location identification technique, on the basis of received TV and/or data signals. (Then (step S3), the (preferably low profile, reduced size, mobile) antenna on the terminal is adjusted in at least one of azimuth and elevation so that it is pointed to the orbital location of the satellite(s) while the vehicle is in motion. Where the signal strength is obstructed by an object such as a building, the terminal will attempt to switch to a cellular overlay network having the same television data. Where a terrestrial television overlay network (e.g., MobiTV) is available, the terminal can continue to receive television signals, typically at a reduced resolution. Finally, in two way embodiments, data is transmitted to the satellite(s) from the antenna while the vehicle is in motion (step S4). Preferably, the terminal is adapted to concurrent reception of data and television signals, most preferably using a modified DVB standard using BPSK and/or spread spectrum.

The main system parameters of one possible embodiment of the disclosed communication system Satellite: e.g., AMC-15 (α 105 WL, may include a data rate of 4.4 Mbps using ¼ BPSK modulation with an antenna dimension of 30 cm×9 cm. In this exemplary embodiment, parameters are optimized for communication geostationary satellite AMC-15 at 105 degrees W.

Another embodiment of the system comprises an exemplary feeder (HCB) station, situated for example in Northern Virginia, comprising reflector antenna with diameter 9 meters and a suitable uplink EIRP (Equivalent Isotropic Radiated Power) to support communication service with the mobile terminals. The antenna for the mobile terminals may be, for example, 270 cm² or about 30 cm×9 cm. The reception data rate may be 4.4 Mbps, using BPSK code rate ¼ modulation with minimum required Eb/No (Energy per bit over noise in 1 Hz bandwidth) of 2 dB.

Additionally, Table 1 below describes several Link Analysis Parameters that may be utilized in an exemplary embodiment of the system. The parameters described in Table 1 are illustrative of exemplary embodiments of the system as described herein.

TABLE 1
Illustrative T3 Link Analysis Parameters

| Hub | Space Segment | Transmission | Remote |
|---|---|---|---|
| Location: | Satellite: US FSS | Data rate: 3-6 | Rx G/T: 1.5-3 |
| northern Virginia | type | Mbps | dB/K |
| Antenna | Satellite G/T: 2-5 | Code rate: 1/4 | |
| diameter: 7.6-9 m | dB/K | | |
| Uplink EIRP: 75- | Satellite | Modulation: | |
| 80 dBW | downlink EIRP: | BPSK | |
| | 45-50 dBW | | |
| | Adjacent Satellite | Min required | |
| | Interference: | Eb/No: 1.8-3 dB | |
| | various amount | | |
| | of ASI was | | |
| | assumed | | |

In exemplary systems, it is often desired to have enough margin to support communication in normal rain conditions. This margin is well known to those skilled in the art.

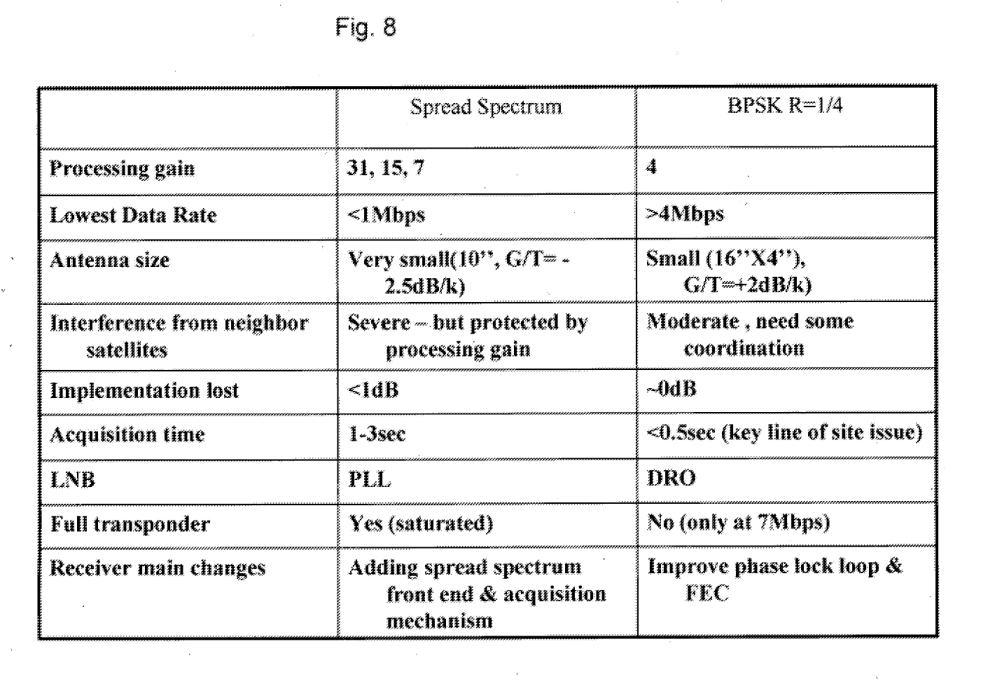

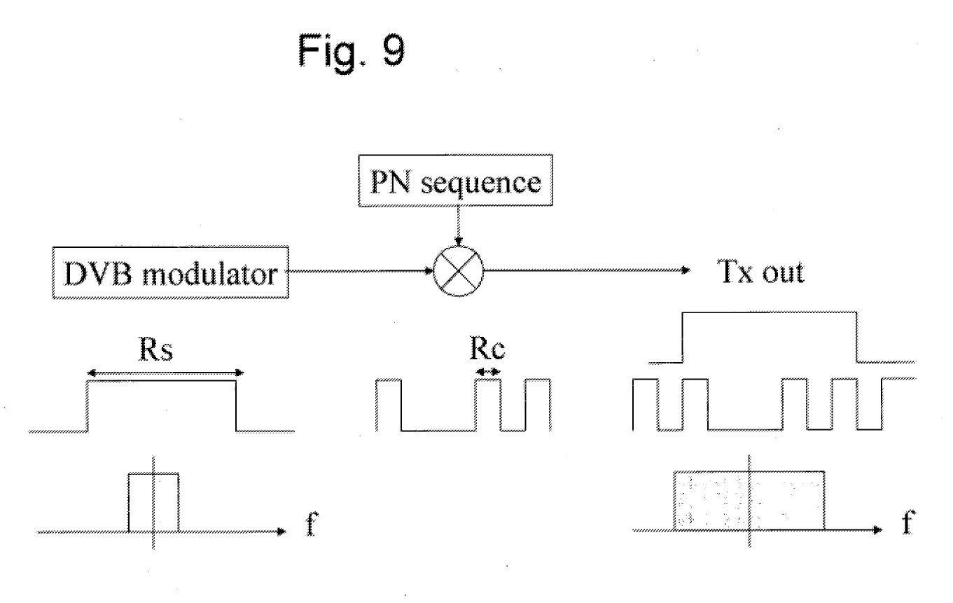

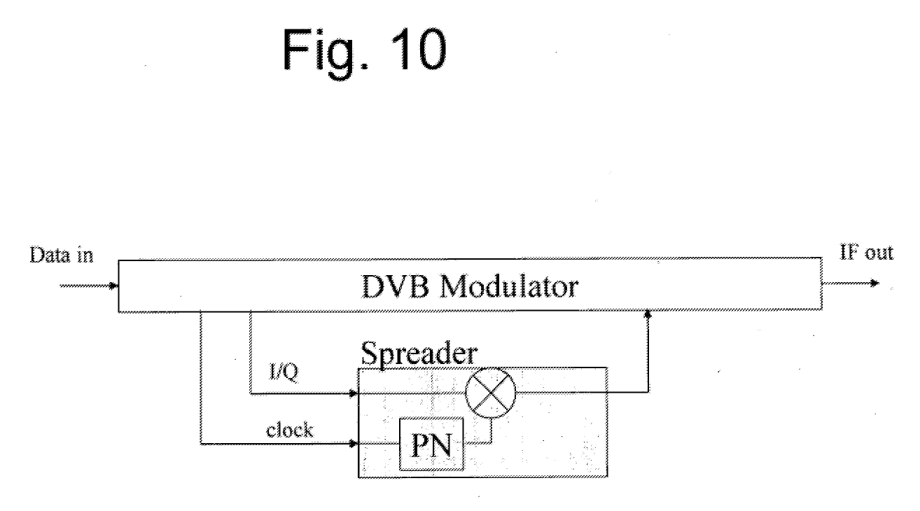

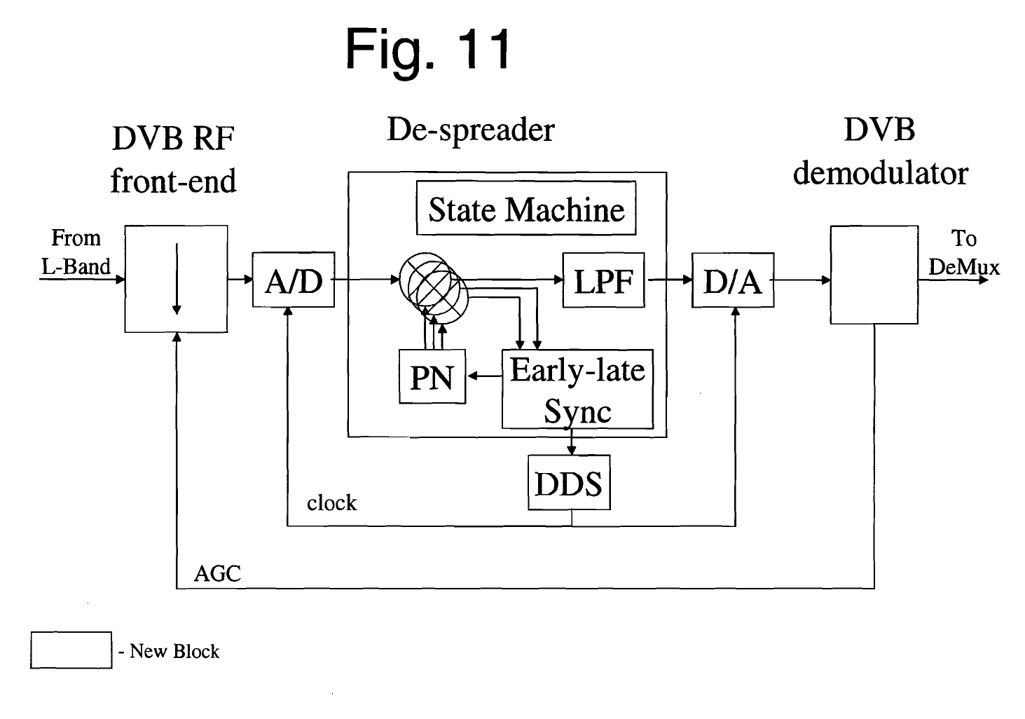

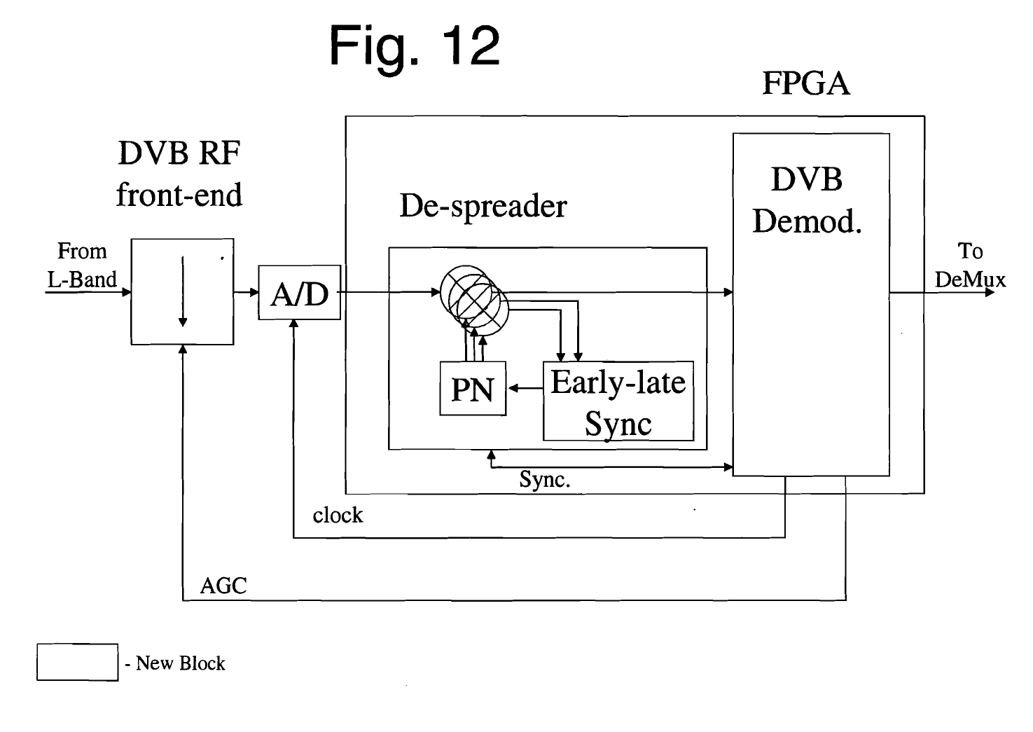

FIG. 9 shows an exemplary embodiment of the full spread spectrum system of FIG. 8 with direct sequence spread spectrum multiplying the DVB signal by a PN (pseudo noise) sequence of −1, −1. FIG. 10 is a block diagram of the transmit section of the spread spectrum embodiment of FIG. 9. FIG. 11 is a block diagram of the receive section of the spread spectrum embodiment of FIG. 9. FIG. 12 is another embodiment of the receive section of FIG. 11.

The foregoing embodiments and advantages arc merely exemplary and are not to be construed as limiting the present invention. The description of the present invention is intended to be illustrative, and is not intended to limit the scope of the claims. Many alternatives, modifications, and variations will be apparent to those skilled in the art.

1. A communication apparatus, comprising:
an antenna; and
a communication terminal, which is connected to the antenna and is coupled to receive from a satellite a first signal carrying a given video transmission at a first image resolution and, responsively to an interruption in receiving the first signal, to switch to receiving from a terrestrial wireless network a second signal carrying the given video transmission at a second image resolution that is lower than the first resolution, so as to present the given video transmission to a user over a period of time containing the interruption.

2. The apparatus according to claim 1, wherein the terrestrial wireless network comprises a cellular network.

3. The apparatus according to claim 1, wherein the first signal is formatted in accordance with a Digital Video Broadcasting (DVB) format.

4. The apparatus according to claim 1, wherein the antenna comprises a flat antenna that is adjustable to track the satellite when the apparatus is in motion.

5. The apparatus according to claim 1, wherein the communication terminal is further coupled to conduct two-way communication via the satellite.

6. A method for communication, comprising:
receiving from a satellite a first signal carrying a given video transmission at a first image resolution;
responsively to an interruption in receiving the first signal, switching to receive from a terrestrial wireless network a second signal carrying the given video transmission at a second image resolution that is lower than the first resolution; and
outputting the given video transmission to a user over a period of time containing the interruption.
